(19) United States
(12) Patent Application Publication
(10) Pub. No.: US 2022/0007663 A1
(43) Pub. Date: Jan. 13, 2022

(54) Improved plant for the treatment of vegetal products

(71) Applicant: Dermasole Società a Responsabilità Limitata Semplificata, Selvazzano Dentro (Padova) (IT)

(72) Inventor: Graziano Zagallo, Selvazzano Dentro (Padova) (IT)

(21) Appl. No.: 17/281,865

(22) PCT Filed: Sep. 27, 2019
(86) PCT No.: PCT/IB2019/058220

§ 371 Date: Mar. 31, 2021

(30) Foreign Application Priority Data
Oct. 1, 2018 (IT) 102018000009070

(51) Int. Cl. A23B 7/015; A23B 7/02; A23N 12/08

(52) U.S. Cl. CPC A23B 7/015; A23N 12/08; A23B 7/02

(57) ABSTRACT

A plant for the treatment of vegetable products includes a chamber having walls arranged to delimit an internal environment, which, during the operation of the plant, is closed and isolated with respect to the external environment, the products to be treated being intended to be positioned within such chamber; a lighting apparatus positioned within the chamber and configured to emit infrared radiation on the products to be treated; a ventilation apparatus to circulate air inside the chamber; and a dehumidification apparatus configured to control humidity conditions inside the chamber.

The present invention relates to an improved plant for treating vegetable products, preferably but not exclusively for food products, and in particular for treating grapes for the production of dried grapes, or for treating apples, hops or other fruits and vegetables generally. Alternatively, the vegetable products treated with the plant according to the invention can be used for example for the production of cosmetics or phytotherapeutic drugs. The present invention also relates to a method for treating food products by means of the aforementioned plant.

At present for the drying of vegetable products, preferably food—and in particular for drying/dehydration of grapes to obtain passito wine—the products to be dried are placed inside a closed room of large size. This room is then appropriately heated mainly by convection, in particular by circulating preheated air, and is also appropriately ventilated, using suitable ventilation plants, so as to create an environment inside with conditions of temperature and humidity suitable for the drying of the products.

This known method generally lasts about 2-3 months, or even more, and serves to cause a loss of water, and therefore of weight, from the product and therefore, for example in the case of grapes, an increase in the concentration of sugars.

This traditional method is not completely satisfactory since it requires rather long times and, moreover, by using environments of considerable size, the control of the temperature and humidity conditions within said environments is rather complicated, as well as subject to changes in external temperature and humidity and in any case, it is not optimal and homogeneous. Furthermore, the energy costs for heating the air to be introduced into the rooms, as well as for the circulation of the air inside the rooms, are quite high.

Further, to prevent animals, such as mice, birds, or insects, from entering the premises, appropriate measures are used such as traps or repellents. In this regard, it is easy to see how the use of repellents in the vicinity of food products to be dried is highly undesirable as there is a risk of contaminating these products.

Another drawback of the aforementioned traditional method is due to the high humidity which is developed in such environments and which, therefore, promotes the development of fungi or molds. In this situation, to avoid or slow down the development of molds or fungi, which degrade the products to be dried, suitable chemicals are used that risk to be harmful to the foodstuffs to be dried.

Yet another drawback is due to the fact that, inside the room, the products are usually positioned in a suspended condition or laid on suitable shelves and, therefore, their handling is rather complicated and laborious, necessarily requiring the use of manual labour. Moreover, in the case of small products such as grapes, this movement inevitably leads to the loss of grains.

Another method already known for drying vegetable products provides for their treatment in closed cells and cooled to temperatures of about −50° C. This method requires high management costs due to the need to cool medium/large rooms, and furthermore, being an extremely rapid process, in many cases it leads to a degradation of the final product.

KR20180003343 describes a hybrid method for drying food products, which involves inserting the products to be treated in a closed environment, where the irradiation with ultraviolet and infrared light is provided and the creation of convective air movements by means of the drive of a fan. However, this method is not fully satisfactory since the air remains always and only within the closed environment and, therefore, after a certain interval of time, tends to saturate with humidity, thus making the process slower and less efficient. Furthermore, to achieve efficient drying, this method involves bringing the products to be dried at particularly high temperatures, above 150° C., thus causing an inevitable degradation of the products themselves.

DE202008012544, WO2018124911 and WO 2011/037376 describe a method and a plant for drying agricultural products, and in particular products of vegetable or animal origin, even marine. In particular, the products to be dried continuously pass through a conveyor belt to a treatment chamber which is open at both ends to allow the entry and exit of said conveyor belt. A plurality of infrared lamps is installed inside the treatment chamber to raise the temperature of the products to be dried. However, this method is not fully satisfactory since the drying inside a continuous conveyor is less controllable than that inside a closed environment and, in particular, the temperature and humidity conditions are difficult to control accurately.

US2003/0150127 describes a method for extending the expiration of food products, and in particular for drying a protective layer, preferably of wax, positioned on the surface of said products through an accelerated drying method. In particular, the method provides to position the products, once covered with said protective layer, on a continuous conveyor belt and to subject them to irradiation with infrared lamps.

The object of the invention is to propose an improved plant and method for treating vegetable products which overcome the aforementioned drawbacks provided in traditional solutions.

Another object of the invention is to propose a plant and a method which are alternative and improved with respect to traditional solutions.

Another object of the invention is to propose a plant and a method which allow to reduce the time required for drying vegetable products.

Another object of the invention is to propose a plant and a method which allow to reduce the space required for the treatment, thus avoiding the need to have sheds or large rooms at disposal.

Another object of the invention is to propose a plant and a method that are highly hygienic, in particular limiting the manual handling of the products to be treated.

Another object of the invention is to propose a plant and a method that do not require the use of repellents to deter animals.

Another object of the invention is to propose a plant and a method which allow to completely avoid the formation of fungi or molds without requiring the use of fungicidal products or other chemical additives which could be harmful.

Another object of the invention is to propose a plant and a method which allow to reduce the management costs, in particular by reducing both the energy consumption and the use of manual labour.

Another object of the invention is to propose a plant that is particularly efficient from the energy point of view and which, in particular, allows to obtain a reduction in the drying times of vegetable products.

Another object of the invention is to propose a plant and a method which, in the case of grape drying treatment, allow to increase the sugar content in the grains of the grape itself.

Another object of the invention is to propose a plant whose construction, installation and maintenance are particularly simple, rapid and inexpensive.

Another object of the invention is to propose a plant with an alternative characterization, in terms of construction, function and performance, compared to the traditional ones.

All these aims and others which will emerge from the description which follows are achieved, according to the invention, with a plant for the treatment of vegetable products, preferably of food products, in particular of fruit and vegetables, having the characteristics indicated in claim 1 and with a method having the characteristics indicated in claim 15.

Suitably, the improved plant 1 for treating vegetable products, preferably vegetable products for food use, is characterized in that it comprises:

a chamber comprising walls arranged so as to delimit together a closed environment within which the products to be treated are destined to be positioned,

a lighting apparatus positioned inside said chamber and configured so as to emit infrared light radiations on the products 8 to be treated destined to be positioned inside the chamber,

a ventilation apparatus to circulate the air inside the chamber,

a dehumidification device configured to control the humidity conditions inside the chamber.

Conveniently, the walls of said chamber comprise at least one innermost layer of reflective material.

Advantageously, said innermost layer is made of galvanized steel.

Advantageously, a layer of highly reflective material, preferably of aluminium, is associated with said inner layer.

Conveniently, the plant is characterized in that it is equipped with moving means to allow and/or facilitate its movement.

Advantageously, the walls of said chamber comprise at least one outer layer in thermally insulating material. Preferably, said intermediate layer is made of expanded polyurethane. Preferably, said intermediate layer has a thickness of between 1 and 10 cm, and preferably at least 3 cm.

Conveniently, said walls are configured to define a closed insulated environment with respect to the outside.

Conveniently, the plant is characterized in that it comprises a single door for the passage to and from the environment. Preferably, the release of said door to allow its opening is controlled by a timed mechanism. Conveniently, said timed mechanism can be set to keep the door closed for a certain time based on the quantity of products to be dried. Moreover, said timed mechanism can be set to keep the door closed for a certain time based on the percentage of humidity of the products to be treated.

Conveniently, said lighting apparatus comprises a plurality of lighting modules which are associated and/or supported by the walls of said chamber.

Advantageously, said lighting apparatus is configured to emit light radiations in the range 700 nm-1 μm on the products to be treated.

Advantageously, said lighting apparatus is configured so as to also emit ultraviolet light radiations on the products to be treated destined to be positioned inside the chamber.

Conveniently, said lighting apparatus is configured so as to emit light radiations in the range 100-400 nm on the products to be treated.

Advantageously, said lighting apparatus comprises:

at least a first illumination source for emitting light radiations in the infrared spectrum, and

at least one second light source for emitting light radiations in the ultraviolet spectrum.

Advantageously, said lighting apparatus further comprises a third illumination source configured to emit radiation in the visible light spectrum.

Conveniently, said lighting apparatus comprises lighting devices configured to simultaneously emit infrared, ultraviolet and/or light radiations in the visible spectrum.

Advantageously, said light sources are LEDs. Advantageously, said light sources are tubular fluorescent lamps. Advantageously, said light sources are metal halide lamps. Advantageously, said light sources are resistance lamps.

Advantageously, each lighting device has a power of between 25 and 300 W, and preferably 60-160 W.

Conveniently, said lighting modules are arranged so that the lighting devices are oriented vertically.

Advantageously, each lighting module is associated with a respective electrical supply unit housed outside the chamber.

Conveniently, said ventilation apparatus comprises at least one first fan and at least one second fan. Preferably, said first fan is positioned at a higher height than a second fan. Preferably, said at least one first fan is positioned at the ceiling wall of said closed environment. Preferably, said at least one second fan is positioned below with respect to the lighting modules.

Advantageously, said dehumidification apparatus comprises an air circulation circuit which is fluidly connected with the internal environment of said chamber and which is fluidically isolated/separated from the external environment.

The plant conveniently comprises an apparatus for regulating the internal temperature (not shown). Preferably, said apparatus can be integrated inside the dehumidification apparatus.

Conveniently, the plant also comprises at least one sensor for detecting the temperature and/or humidity conditions inside the chamber.

Advantageously, the plant also comprises a control unit connected to said lighting apparatus, to said ventilation apparatus and/or to said dehumidification apparatus. Conveniently, the control unit is also connected to said at least one sensor and is configured to automatically control the temperature and/or humidity conditions inside said chamber.

Advantageously, the plant comprises a sanitizing apparatus. Preferably, said sanitizing apparatus is configured to circulate ozone inside said chamber.

Conveniently, the plant comprises a control unit for controlling said lighting apparatus, said ventilation apparatus, said dehumidification apparatus and said apparatus of sanitation.

Conveniently, said command and control unit is configured to activate said apparatuses on the basis of the measurements made by at least one sensor provided inside the chamber.

The invention also relates to a method for treating vegetable products, preferably but not exclusively of food products, and in particular for treating grapes for the production of dried grapes, by means of a plant as described above.

The method conveniently comprises at least one cycle which, in turn, comprises the sequence of the following steps:

a first step in which said ventilation apparatus remains always activated and in which, moreover, the lighting apparatus is activated, at least temporarily, to reach and/or maintain the desired temperature,

a second step in which the lighting apparatus is always deactivated and in which the ventilation apparatus remains always activated.

Conveniently, the method is characterized in that during said first step the dehumidification apparatus remains deactivated.

Advantageously, the method is characterized in that during said first step the temperature inside said chamber is maintained between about 10-60° C., and preferably at about 35-38° C.

Conveniently, the method is characterized in that during said second step said dehumidification apparatus is activated, at least temporarily, to maintain the desired humidity conditions.

The method is conveniently characterized in that during said second step said dehumidification apparatus is activated, at least temporarily, to maintain, within said chamber, a humidity of about 10-90%, and preferably 65-75%.

Suitably, the method is characterized in that said steps are repeated a sufficient number of times to obtain a final product with the desired degree of humidity.

Conveniently, the method is characterized in that said products to be dried are suitably raised and/or spaced from the floor.

The present invention is further clarified hereinafter in some of its preferred forms of practical embodiment, given for purely exemplary and non-limiting purposes, with reference to the attached tables of drawings, in which:

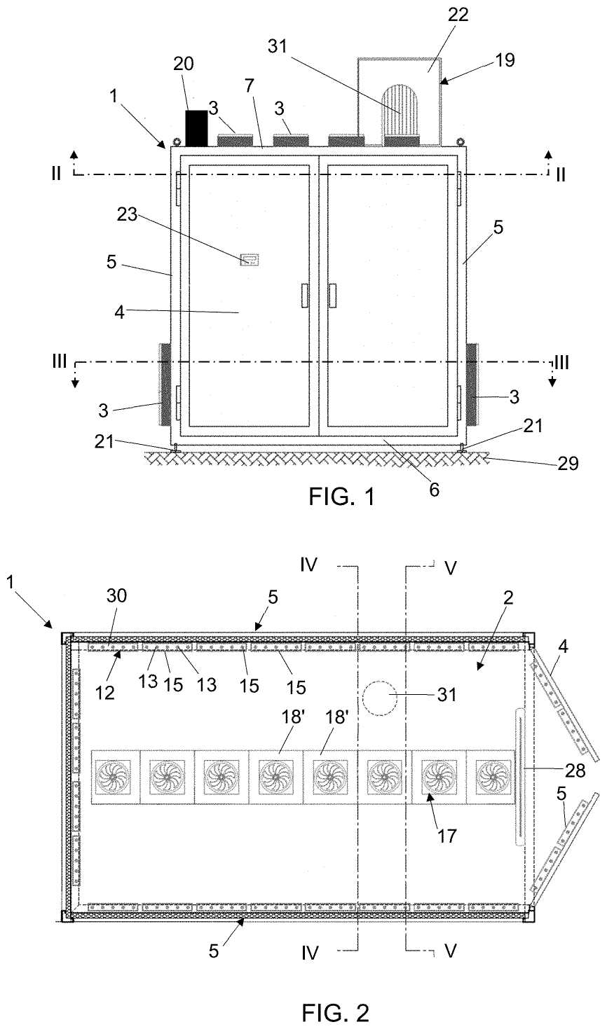

FIG. 1 shows in front view an improved plant according to the invention,

FIG. 2 shows it according to section II-II of FIG. 1,

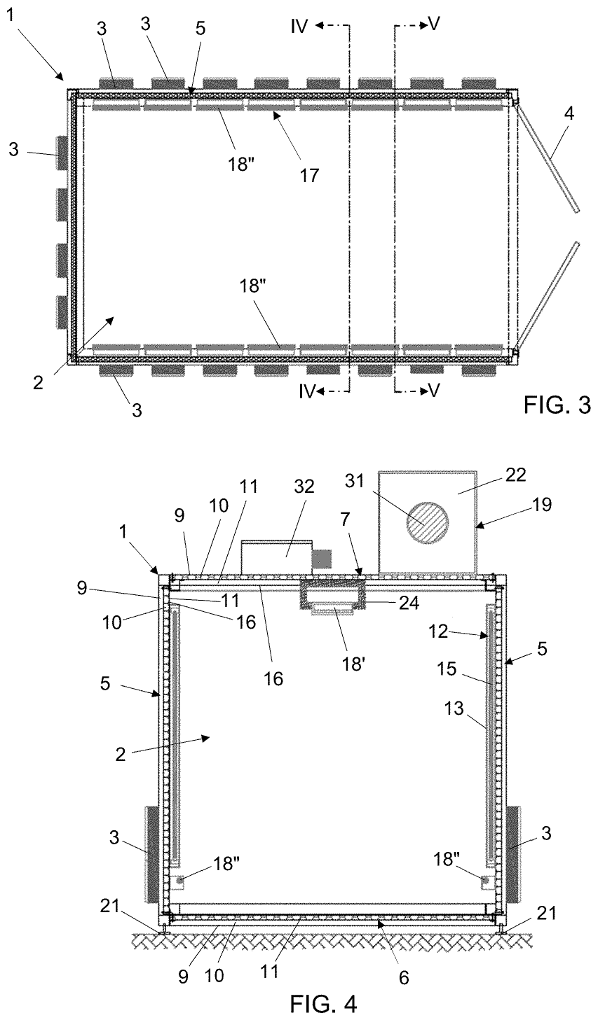

FIG. 3 shows it according to section III-III of FIG. 1,

FIG. 4 shows it according to section IV-IV of FIG. 2,

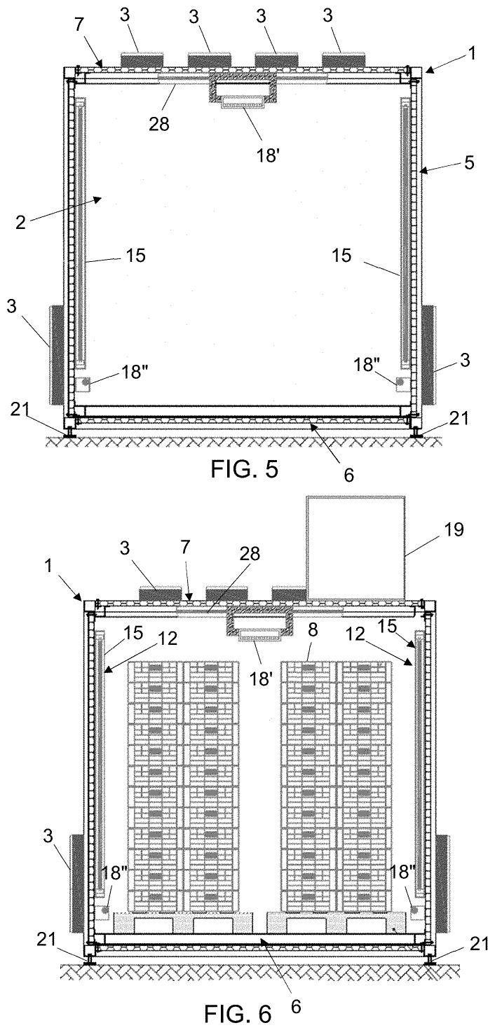

FIG. 5 shows it according to the section V-V of FIG. 2,

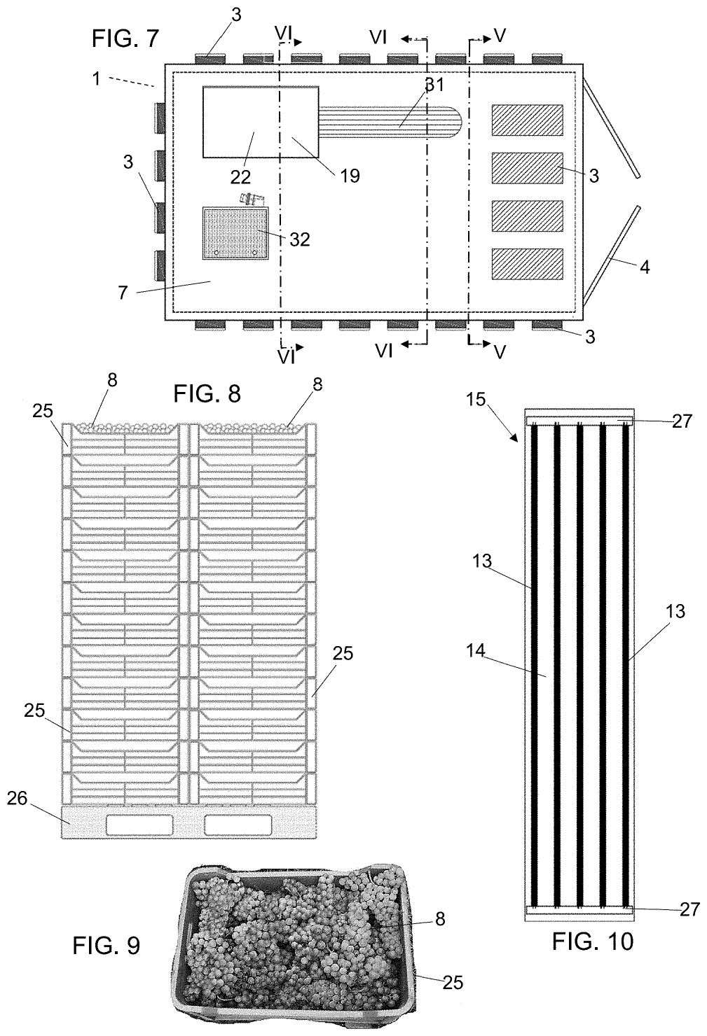

FIG. 6 shows it according to the section VI-VI of FIG. 7 with the products to be treated inside,

FIG. 7 shows it according to a plan view,

FIG. 8 shows a front view of an example of how the products to be treated are positioned and organized inside the plant according to the invention,

FIG. 9 shows in perspective view a box containing the grapes to be treated,

FIG. 10 shows in front view a lighting module.

In the following, an embodiment of the plant 1 for the treatment of grapes 8 will be described, in particular for drying and sterilizing/sanitizing grapes destined then to be used for the preparation of raisin wine, however it is understood that the same plant it can also be used for the treatment of apples, hops, kiwis or other fruits and/or vegetables, or of herbs, flowers and/or leaves of various plants (for example hemp), as well as other vegetable products in general, for food use or to be used directly, or following further treatments, in cosmetics or herbal medicines.

As can be seen from the figures, the plant 1 for the treatment of vegetable products 8, in particular products for food use, preferably for the drying and sanitizing/sterilizing treatment of said vegetable products 8, comprises a chamber or cell 2 which it is closed on all its sides and, suitably, it is provided with at least one door 4 to allow the operator access to the inside of the same chamber.

In particular, the chamber 2 is preferably of parallelepiped shape, and comprises substantially vertical side walls 5 closed at the top by a substantially horizontal ceiling wall 7 and below by a substantially horizontal floor-mounted wall 6, which together delimit a closed environment, isolated from the external, and inside which the products 8 to be treated are intended to be positioned. Alternatively, the chamber 2 can have a substantially spherical or ovaloid shape, so as to better distribute the forces acting on the walls. Preferably, the vegetable products 8 to be treated are arranged inside the chamber 2 in an orderly manner and are appropriately raised and/or spaced with respect to the floor 6.

Conveniently, at one of the side walls 5, said door 4 is provided which is configured to allow the passage to operators, products 8 and, advantageously, also to means (for example transpallets) for moving pallets 26 on which the containers 25 are laid with said products to be treated.

Advantageously, an electric lock with manual or automatic control is associated with said door 4. Preferably, the opening of the lock associated with said door 4 can be controlled by a timed mechanism configured to keep the lock locked, and therefore prevent the opening of the door 4, during the treatment of the products, and to unlock the lock, and allow thus the opening of said door, after a predefined time, which can be set/defined for example based on the quantity of products to be dried and/or their percentage of humidity, and/or other suitable parameters.

Conveniently, the unlocking of the lock associated with the door can also be controlled by an appropriate authorization procedure (for example by inserting a key and/or inserting a suitable code and/or using a biometric identifier), or by means of a special emergency button. Alternatively, the door can be equipped with a manual release mechanism.

Advantageously, under closed door conditions, the latter is sealed, so as to achieve a watertight separation between the interior of the chamber 2 and the external environment. Preferably, moreover, the door can have a thermal break.

Advantageously, the chamber 2 is configured so as to define an insulated environment inside it, and in particular insulated from the thermal point of view, with respect to the outside. Moreover, the chamber 2 can be configured to define a watertight environment inside it, that is, such as not to allow any gas exchange with the external atmosphere.

Advantageously, the side walls 5 and/or the ceiling walls 7 and/or floor 6 consist of at least one thermally insulating layer 10 and at least one layer 11, more internal than the aforementioned insulating layer 10, which is made of reflective material, to reflect inward and the heat generated inside the chamber 2.

Preferably, the side walls 5 and/or the ceiling walls 7 and/or floor 6 are constituted by a multilayer comprising:

an outer layer 9, preferably in metal (for example in stainless, or galvanized or food steel or aluminium, or can be painted),

an intermediate layer 10 in a thermally insulating material, for example expanded polyurethane, preferably, the intermediate layer has a thickness of at least 2 cm, and preferably of about 5 cm,

an inner layer 11 made of reflective material, preferably of metal (for example, stainless steel, galvanized or food-grade, and/or aluminium, also food-grade, or a painted opaque wall), the material can be appropriately selected based on the reflectivity characteristics. requests.

Conveniently, the walls can have a thickness of between about 1 and 10 centimetres, and preferably at least about 3 cm. In particular, thinner walls allow more effective heat exchange with the outside, while thicker walls allow better thermal insulation from the outside.

Preferably, to the inner layer 11 of said walls 5, 6 and/or 7 is associated a lamina 16 made of highly reflective material, preferably of metal, such as for example aluminium with a high reflecting coefficient.

Advantageously, the floor wall 6 is knurled and made of reflective material, preferably metal.

Advantageously, the chamber 2 is also provided with means 21 (for example of legs) to keep it in a raised condition with respect to the lower external surface 29 on which the plant 1 is positioned.

Advantageously, the chamber 2 can be provided with movement means (for example of wheels, not shown) to allow and/or facilitate its movement.

Conveniently, the products 8 to be treated are arranged inside the chamber 2 preferably in a raised position with respect to the floor 6.

Advantageously, the products 8 to be treated are arranged inside the chamber 2 so as to be appropriately spaced from each other so as to allow the passage of air between them. Preferably, the products 8 to be treated can conveniently be positioned in containers 25 arranged on pallets 26 (see FIGS. 6 and 8). Preferably, inside the chamber 2, suitable structures or furniture may be provided, for example of cabinets or shelves, provided with support surfaces for the products 8 to be treated.

The plant 1 comprises, inside the chamber 2, a lighting apparatus 12 configured and positioned so as to emit light radiations in the infrared spectrum on the products 8 to be treated present inside the chamber itself.

Advantageously, the lighting apparatus 12 is configured so as to also emit ultraviolet light radiations on the products to be treated which are be positioned inside the chamber 2.

Advantageously, the lighting apparatus 12 comprises a plurality of lighting modules 15 which, appropriately, are associated or supported—preferably they are mechanically anchored—to the inner surfaces of the side walls 5 of the chamber 2 and, preferably, also on the door 4.

Preferably, each module 15 comprises at least two (for example five) lighting devices 13 (see FIG. 10).

Conveniently, each lighting device 13 is configured to emit, both simultaneously and in sequence, light radiations in the infrared spectrum (preferably in the range 700 nm-1 μm) and in the ultraviolet spectrum (preferably in the range of 100-400 nm) and, preferably, also in the visible light spectrum (preferably in the range 400-700 nm).

Conveniently, the light radiations in the infrared spectrum heat the product to be treated mainly by radiation; in particular, by heating the product mainly by radiation, they the water contained in the latter is evaporated, thus causing its drying. Conveniently, the lighting apparatus 12 also heats the air which is around the apparatus itself and which is present inside the chamber 2 and, therefore, it is understood that a part of the heat perceived inside said chamber is due to heat transmission by convection.

Suitably, the light radiations in the ultraviolet spectrum have a bactericidal and fungicidal action, thus sanitizing/sterilizing the product.

Appropriately, light radiations in the visible spectrum stimulate photosynthesis and, in the case of grapes, sugar production.

Advantageously, each lighting device 13 can comprise:

a first light source for emitting light radiation in the infrared spectrum, and

a second light source for emitting light radiation in the ultraviolet spectrum.

Advantageously, each lighting device 13 can also comprise a third illumination source for emitting light radiations in the visible light spectrum.

Conveniently, as shown in FIG. 10, the lighting sources of the lighting devices 13 can be LEDs configured to emit the relative light radiations. Preferably, each lighting device 13 comprises all three lighting sources which are individually controlled so as to be able to emit the corresponding different light radiations in sequence or even simultaneously.

Advantageously, each lighting device 13 can be constituted by a tubular fluorescent lamp (i.e. a “neon” lamp) configured to emit radiation in the infrared and ultraviolet spectrum and, preferably, also in the visible light spectrum. Alternatively, each lighting device can be constituted by an incandescent lamp, i.e. in which the light radiation is emitted by the overheating of a metal element, in particular of a resistance. Alternatively, each device can consist of a metal halide lamp. Conveniently, each module 15 can comprise a plurality of devices 13 of the same type. Alternatively, each module 15 can comprise a plurality of devices of different types. Advantageously, each lighting device 13 has a light output of 25-300 W, preferably 60-160 W.

Conveniently, as stated, the lighting devices 13 are organized in modules 15 in order to facilitate their installation, removal and maintenance. Preferably, each module 15 comprises a metal panel 14 provided frontally with lamp-holder 27 and at the rear of electrical connection cables. Conveniently, the lamp holders 27 are electrically connected to said cables and are arranged so that the corresponding lamp—once installed—is vertically oriented (see FIG. 10).

Advantageously, each lighting module 15 is associated with a corresponding electrical supply unit which is housed inside a box 3 which, preferably, is positioned outside the chamber 2, or alternatively can be positioned inside the chamber itself. Conveniently, each box 3 is associated with the external surface of the vertical walls 5 or of the ceiling wall 7 and is connected to the corresponding lighting module 15 by means of electrical connections which pass through holes passing from one side to the other of the vertical walls 5 or of the ceiling wall 7, thus allowing the passage of the electric cables from the power supply unit housed in the box 3 (which is positioned outside the chamber 2) to the lighting module 15 (which is positioned inside the chamber 2). Conveniently, the power supply units housed inside the boxes 3 and mounted externally on the ceiling wall 7 are connected to the lighting modules 15 mounted on the door 4.

The plant 1 further comprises one or more courtesy lights 28 to illuminate the interior of the chamber 2.

The plant 1 further comprises a ventilation apparatus 17 for circulating the air inside the chamber 2.

Suitably, the ventilation apparatus 17 comprises a plurality of fans installed inside the chamber 2. Advantageously, the ventilation apparatus 17 comprises at least a first fan 18′ which is placed at a height (defined with respect to the floor 6) higher than at least a second fan 18″ . In particular, first fans 18′ (preferably centrifugal and orientable) are provided which are positioned at the ceiling wall 7 of the chamber 2, and second fans 18″ (preferably of the tangential type) which are positioned below with respect to the lighting modules 15 hanging from the side walls 5. Alternatively, the first fans 18′ can be of the tangential type and the second fans 18″ can be of the centrifugal and orientable type. Preferably, the first fans 18′ are fixed and supported at the ceiling wall by a suitable frame 24.

The plant 1 also comprises a dehumidification apparatus 19 for reducing the humidity of the air present inside the chamber 2.

The dehumidification apparatus 19 is preferably installed outside the chamber 2 (in correspondence with the ceiling wall or a side wall), or alternatively it can be integrated inside the chamber itself. The dehumidification apparatus 19 is configured to extract the air from/to said chamber and then return it, once dehumidified, inside the chamber itself. In particular, the dehumidification apparatus 19 comprises a dehumidifier 22 provided with corresponding first ducts 31 for extracting and re-introducing air into the chamber 2. For example, the first ducts 31 can connect to the chamber 2 through at least one first air outlet opening from chamber 2 and a second air re-entry opening inside the chamber. Suitably, both openings can be watertight, so that the internal environment is still isolated from the external environment.

Conveniently, if the dehumidification apparatus 19 is integrated inside the chamber 2, the first ducts 31 may not be present.

In particular, therefore, the dehumidification apparatus 19 comprises a closed circuit, i.e. not communicating with the outside, in which the air that is extracted from the chamber circulates and then is reintroduced into the latter, once it has been dehumidified.

Advantageously, the plant 1 can also comprise a sanitizing apparatus 20. Preferably, said sanitizing apparatus 20 can be mounted outside the chamber 2 and be communicating with the inside of said chamber to be sanitized. Conveniently, the sanitizing apparatus can be integrated into the dehumidification apparatus. Alternatively, it can be connected with the chamber 2 by means of appropriate second ducts 32. Preferably, said sanitizing apparatus 20 can use ozone (O₃) and, in particular, it can be configured to inject and circulate ozone inside chamber 2 and/or ducts 31, 32.

Advantageously, the plant 1 can comprise means for introducing into the chamber 2 other gases, preferably inert gases, in order to create inert atmospheres and/or in any case suitable for the dehydration/drying of the products and/or to their sanitization. For example, nitrogen (N₂) and/or carbon dioxide (CO₂) or mixtures thereof, or other inert gases such as argon can be introduced. The partial pressure of each gas inside the chamber can be suitably adjusted.

Advantageously, the interior of the chamber 2 can be fluidically connected to a compressor to control the pressure inside the chamber itself. Preferably, said compressor can be configured to create and maintain a vacuum condition within the chamber itself, thus speeding up the dehydration of the products to be treated. Preferably, the compressor for creating the vacuum can be activated during the operations that lead to the removal of humidity from the products to be treated, since they allow to remove moisture from the atmosphere present inside the chamber itself.

Conveniently, the plant 1 comprises an apparatus (not shown) for regulating the internal temperature of the chamber 2. Preferably said apparatus can be integrated inside the dehumidification apparatus. Preferably said temperature regulation apparatus allows to regulate the internal temperature between 5 and 65° C. Advantageously, said internal temperature regulation apparatus can comprise a chiller and/or a heat pump, or a heating element, or any other device which, preferably, are connected or integrated in the dehumidification apparatus.

Advantageously, the plant 1 is provided with a control unit, for example a PLC processor, for controlling the lighting apparatus 12, the ventilation apparatus 17 and the dehumidification apparatus 19. Suitably, the control unit is associated with an interface panel 23 provided with traditional input means (for example buttons or touchscreen) and/or display (for example monitor).

In particular, the control unit controls, commands and manages the various apparatuses 12, 17 and/or 19, as well as constantly monitors all the process variables so as to create inside the chamber 2 the conditions of humidity, temperature and/or air speed/flow rate suitable for treating plant products contained in the chamber itself. Conveniently, the control unit can be remotely controlled, through radio signals and/or internet by the user. Advantageously, the plant 1 is provided with sensors (not shown) installed inside the chamber 2, to detect the temperature and/or humidity inside the chamber itself. Conveniently, the sensors can also be positioned close to and/or in correspondence with the products to be treated, for example they can be mounted on the boxes or containers of the products to be treated. Conveniently, the sensors are connected to the control unit which, advantageously, is configured to control the various apparatuses 12, 17 and/or 19 correspondingly and automatically on the basis of the values detected by said sensors. Conveniently, the sensors can be connected to the control unit by cables or wirelessly (Bluetooth, Wi-Fi, or by infrared or otherwise).

Advantageously, sensors (not shown) connected to the input door 4 are also provided. These sensors are connected to the plant 1 control unit which is configured so as to stop the lighting apparatus 12 and/or ventilation 17 and/or dehumidification 19 in the event of the door being opened, whereas when the aforementioned apparatuses are active.

Advantageously, the control unit is also connected to the sanitizing apparatus and/or to the compressor and/or to the temperature regulation apparatus to suitably control them. Advantageously, the plant 1 is provided with pressure sensors installed inside the chamber 2, to detect the pressure inside the chamber itself and correspondingly control the compressor for creating the vacuum.

Conveniently, the plant 1 has an electrical panel 33 to be connected to the mains supply and connected directly, by means of suitable cables, with the lighting apparatus 12 and with the ventilation apparatus 17 and/or with the dehumidification apparatus 19 for their electric power supply. Furthermore, preferably, the electrical panel 33 is connected to the electrical supply unit, which is housed inside each box 3, and it is then this unit which is connected to each lighting module 15 of said lighting apparatus 12.

Advantageously, outside the chamber 2, preferably in correspondence with the ceiling 7 or in an easily visible area, a luminous indicator (not shown) is provided to indicate the on/off operating status of the plant 1.

The plant 1 is advantageously equipped with an emergency switch (not shown) for switching it off.

Conveniently, the plant 1 according to the invention is suitable for being used for the drying and/or “passimento” and/or dehydration and sanitation/sterilization treatment of vegetable products. In particular, by “passimento” we mean a process that leads to the removal from the products of a quantity of humidity of about 5-40%, by drying we mean a process that leads to the removal from the products of a quantity of humidity of about 25-65%, dehydration means a process that leads to the removal from the products of a quantity of humidity of about 65-85%.

In particular, a method for drying and sanitizing/sterilizing vegetable products by means of the plant 1 according to the invention is illustrated below by way of non-exclusive example for the preparation of raisins.

Advantageously, the grapes are arranged in suitable containers, for example in containers 25, which are then laid on pallets 26 which, in turn, are then positioned inside the chamber 2 of the plant 1 crossing the door 4. Preferably, the containers 25 with the products 8 are first prepared and positioned on the pallets 26 outside the chamber 2 so that, subsequently, by means of pallet trucks, the pallets thus prepared can be moved and brought in sequence within said chamber.

Conveniently, once all the grapes 8 to be treated have been positioned inside the chamber 2, the door 4 is closed so as to create a closed and isolated/separated environment from the outside.

At this point, therefore, a work cycle is carried out at least once, which includes the sequence of the following steps:

a first step in which the dehumidification apparatus 19 remains always off, while the ventilation apparatus 17 and the lighting apparatus 12 are activated at least for a certain interval; suitably, during this step, the lighting apparatus 12 is activated so as to create and/or maintain a certain desired temperature range or value within the chamber,

a second step in which the lighting apparatus 12 is always off, the ventilation apparatus 17 remains active while, advantageously, the dehumidification apparatus 19 remains active for the time necessary to maintain the desired humidity inside the chamber 2.

In particular, during said first stage, the lighting devices 13 emit—simultaneously or in sequence—light radiation in the infrared spectrum and/or ultraviolet and, preferably, also the visible range.

Conveniently, during the first step, the control unit controls the lighting apparatus 12, and in particular the emission of the infrared heating radiation, so that the temperature inside the chamber 2 is maintained in a temperature range of about 10-50° C., and preferably about 35-38° C. In particular, it is understood that, during the first step, after a first activation period, a second period for switching off the lighting apparatus 12 or, at least for interrupting the emission of the infrared radiation, while the emission of ultraviolet radiation and/or visible light can remain active is present.

Preferably, during the second step, the dehumidification apparatus 19 is turned on for a period necessary to maintain the humidity inside the chamber 2 at about 10-90%, preferably at about 65-75%.

Advantageously, the aforementioned work cycle is repeated at least once, or in any case until the desired characteristics of the product are obtained. For example, the work cycle is repeated eight to ten times to obtain raisins, or even more in the case of white grapes. Appropriately, depending on the number of work cycles, a drying, “passimento” or dehydration effect of the treated products can be obtained.

Appropriately, the first step can last about 3-9 hours. Appropriately, the second step can last about 2-5 hours.

Advantageously, the sanitizing apparatus 20 can be activated during the aforementioned steps. Preferably, the sanitizing apparatus 20 and the lamps configured to emit radiations in the ultraviolet spectrum are alternately activated.

Conveniently, a sanitizing step can be provided during which the ventilation apparatus is active and the sanitizing apparatus 20 is active. Advantageously, said sanitizing step can be carried out at any time, both prior to the first step, and after the second step, as well as between the first and second step. Conveniently, during the sanitizing step, the dehumidification apparatus 19 can be active or switched off and is preferably activated if it is necessary to keep the humidity inside the chamber substantially equal to a determined value. Conveniently, during the sanitizing step, the lighting apparatus 12, and in particular the first light sources configured to emit infrared radiation can be active or switched off, and are preferably activated in the event that it is necessary to maintain the temperature at the chamber interior substantially equal to a given value.

Advantageously, the control unit is configured to automatically carry out each work cycle, as well as its repetition. In particular, the control unit can be configured to suitably control—based on the values set by the operator—the duration of the two steps that make up each cycle.

From this it is apparent that the plant according to the invention is more advantageous than the traditional ones since:

it allows to reduce the drying times of the products and to have an important energy saving, thus obtaining a reduction of the related costs,

it allows to reduce the space required for the treatment of products, in particular avoiding the use of large rooms or warehouses,

it is highly hygienic because the direct handling of the products by the operators is minimized,

controlling the humidity within the chamber allows to eliminate the occurrence of mold or moss without having to use chemicals,

using a closed chamber and isolated from the external environment, the use of repellents is completely avoided,

is ecologically sustainable,

is of simpler realization,

it is easily transportable,

allows a high level of sanitation and sterilization, since each component can be disassembled and cleaned,

in the grape drying treatment, it also increases the production of sugars.

1. A plant for treatment of vegetable products comprising:
a chamber comprising walls arranged to delimit together an internal environment, which, during operation of said plant, is closed and isolated with respect to an external environment, said chamber being configured to house the vegetable products to be treated,
a lighting apparatus positioned within said chamber and configured so as to emit infrared radiation on the vegetable products to be treated,
a ventilation apparatus configured to circulate inside the chamber, said ventilation apparatus comprising a plurality of fans installed inside the chamber;
a dehumidification apparatus configured to control humidity conditions inside the chamber; and
one or both of at least one sensor for detecting temperature, humidity, and/or pressure conditions inside the chamber, or a control unit connected to said lighting apparatus, to said ventilation apparatus and to said dehumidification apparatus and to said at least one sensor, for automatically controlling conditions of the temperature and/or the humidity inside said chamber.

2. The plant according to claim 1, wherein the walls of said chamber comprise at least one innermost layer of reflective material.

3. The plant according to claim 1, wherein the walls of said chamber comprise at least one outermost layer made of a thermally insulating material.

4. The plant according to claim 1, further comprising at least one door configured to be sealed in a watertight manner.

5. The plant according to claim 4, wherein said walls and said door are configured to define an insulated environment with respect to the external environment.

6. The plant according to claim 1, wherein said dehumidification apparatus comprises a circuit fluidically connected to the internal environment of said chamber and fluidly separated with respect to the external environment.

7. The plant according to claim 1, wherein said lighting apparatus comprises a plurality of lighting modules, which are associated and/or supported by the walls of said chamber.

8. The plant according to one or more of the preceding claim 1, wherein said lighting apparatus is configured so as to emit ultraviolet light radiations on the vegetable products (8) to be treated and to be positioned inside the chamber.

9. The plant according to claim 1, wherein said lighting apparatus comprises:
a first light source for emitting light radiation in an infrared spectrum, and
a second light source for emitting light radiation in an ultraviolet spectrum.

10. The plant according to claim 1, wherein the ventilation apparatus comprises at least one first fan and at least one second fan, said first fan being positioned at a higher height than a second fan.

11. The plant according to claim 1, further comprising a sanitizing apparatus configured to introduce and/or circulate ozone inside said chamber.

12. The plant according to claim 11, further comprising an apparatus for regulating the temperature inside said chamber.

13. The plant according to claim 12, further comprising a control unit, which is connected to said at least one temperature, pressure, and/or humidity sensor provided inside the chamber and which is configured to control, based on measurements obtained from said at least one sensor,
said lighting apparatus,
said ventilation apparatus,
said dehumidification apparatus,
said sanitizing apparatus, and
said apparatus for regulating the temperature of said chamber.

14. (canceled)

15. The plant claim 13, wherein the plant is configured to implement a method for treating the vegetable products comprising at least one cycle, the at least one cycle comprising a sequence of the following steps:
a first step, in which said ventilation apparatus always remains activated and in which, the lighting apparatus is activated, at least temporarily, to reach or maintain a desired temperature; and
a second step, in which the lighting apparatus remains always deactivated and in which the ventilation apparatus always remains activated.

16. The plant according to claim 15, wherein, during said first step, the dehumidification apparatus remains deactivated.

17. The plant according to claim 15, wherein, during said first step, the temperature inside said chamber is controlled so as to be maintained between about 10-60° C.

18. The plant according to claim 15, wherein, during said second step, said dehumidification apparatus is activated, at least temporarily, to maintain a humidity of about 10-90% inside said chamber.

19. The plant according to claim 15, wherein said sanitizing apparatus is deactivated when said at least one second light source is configured to emit light radiations in the ultraviolet spectrum.

20. The plant according to claim 15, wherein said first and said second steps are repeated a number of times sufficient to obtain a final product with a desired degree of humidity.

21. (canceled)
